(19) United States
(12) Patent Application Publication
(10) Pub. No.: US 2026/0228363 A1
(43) Pub. Date: Aug. 6, 2026

(54) PROCESSING MEDIA CONTENT TO ANONYMIZE BIOMETRIC INFORMATION

(71) Applicant: Motorola Mobility LLC, Chicago, IL (US)

(72) Inventors: Amit Kumar Agrawal, Bangalore (IN); Panduranga Reddy Pailla, Bangalore (IN); Vijayprakash Idlur, Bangalore (IN)

(73) Assignee: Motorola Mobility LLC, Chicago, IL (US)

(21) Appl. No.: 19/047,387

(22) Filed: Feb. 6, 2025

(51) Int. Cl. G06F 21/62; G06F 21/32; G06V 40/50

(52) U.S. Cl. CPC G06F 21/6254; G06F 21/32; G06V 40/53

(57) ABSTRACT

A first device may determine that media content, such as an image or video, captured using the first device depicts biometric information of a user. That is, the media content may expose a biometric identity of the user. The first device may also determine that the media content is to be communicated to one or more second devices. Based on determining that the media content is to be communicated publicly, the first device may anonymize the biometric information in the media content, such as by introducing random parameters to the media content using artificial intelligence (AI). When the biometric information no longer identifies the user, the media content may be communicated to the one or more second devices.

### BACKGROUND

As technology has advanced our uses for computing devices have expanded. One such use is taking images, photos, and videos on mobile devices, such as smartphones. Users may store images on their mobile devices and in some cases, share the images via numerous messaging and photo-sharing applications. However, sharing images of the user or other people may be a cybersecurity risk if such images depict any biometric information of the individuals in the images, such as fingerprints.

### BRIEF DESCRIPTION OF THE DRAWINGS

Embodiments of processing media content to anonymize biometric information are described with reference to the following drawings. The same numbers are used throughout the drawings to reference like features and components:

FIG. 1 illustrates an example system including a computing device implementing the techniques discussed herein;

FIG. 2 illustrates an example operation of the techniques discussed herein;

FIG. 3 illustrates an example of biometric information in accordance with the techniques discussed herein;

FIG. 4 illustrates an example of device authentication in accordance with the techniques discussed herein;

FIG. 5 illustrates an example process for implementing the techniques discussed herein in accordance with one or more embodiments;

FIG. 6 illustrates various components of an example device that can implement embodiments of the techniques discussed herein.

### DETAILED DESCRIPTION

Techniques for processing media content to anonymize biometric information are discussed herein. Generally, numerous messaging and social media applications enable users of mobile devices (e.g., smartphones) to take, post, and share images and videos all using a mobile device. For examples, “selfies,” or self-portrait photographs taken by a user of a mobile device and using the mobile device, have become a popular form of self-expression and social interaction, allowing people to capture and share personal moments with friends, family, and online communities, which may include a public audience. However, with the increasing implementation of high-resolution cameras in mobile devices, selfies may unintentionally expose biometric data of the user, such as fingerprints or facial features, when shared online. Cybercriminals and other parties online may exploit such biometric data using advanced image processing techniques, which may lead to potential security risks such as identity theft, unauthorized access (e.g., to user devices, accounts, etc.), and privacy violations.

To mitigate these issues, the techniques discussed herein provide for processing media content to anonymize biometric information. Specifically, the techniques discussed herein may include processing media content that includes some exposed biometric information (e.g., biometric identity) of a user, which may be potentially subject to hacking or theft if accessible by the public, and removing identifying-aspects of the biometric information from the media content. A user may use a first device (e.g., a mobile device such as a smartphone) to take a selfie or any other media content (e.g., photo, video) that depicts themselves and/or other people. The first device may determine that the media content depicts some biometric information of the user, such as the user's face, eyes, fingerprint, or palm, among other physical characteristics or traits that may be used to identify the user.

The first device may determine that the user plans to communicate or share the media content to one or more second devices. For example, the user may begin to post an image on a photo-sharing or social media platform online, which may be viewed by a public audience. Because the media content is to be shared publicly, the first device may anonymize the biometric information prior to the media content being shared. In some cases, to anonymize the biometric information, the first device may use an artificial intelligence (AI) model. The AI model may introduce random parameters to the media content, effectively de-identifying the biometric information. The first device may communicate the media content to the one or more second devices when the biometric information no longer identifies the user.

The techniques discussed herein improve the operation of an electronic or computing device by improving security of the device itself and improving efficiency of biometric information anonymization. For example, by obscuring biometric information such as fingerprints and facial features in photos, the techniques discussed herein may make it more difficult for hackers and other adverse parties to obtain such biometric information and subsequently the information for identity theft or unauthorized access to the device. Thus, the discussed techniques limit ways in which an unauthorized party may gain access to the device, which may improve the overall security of the device. Similarly, the discussed techniques may improve the user's security on websites and applications that allow photo sharing. Moreover, using AI to introduce noise to the photo may improve efficiency of the process of inpainting or otherwise de-identifying biometric features in the photo.

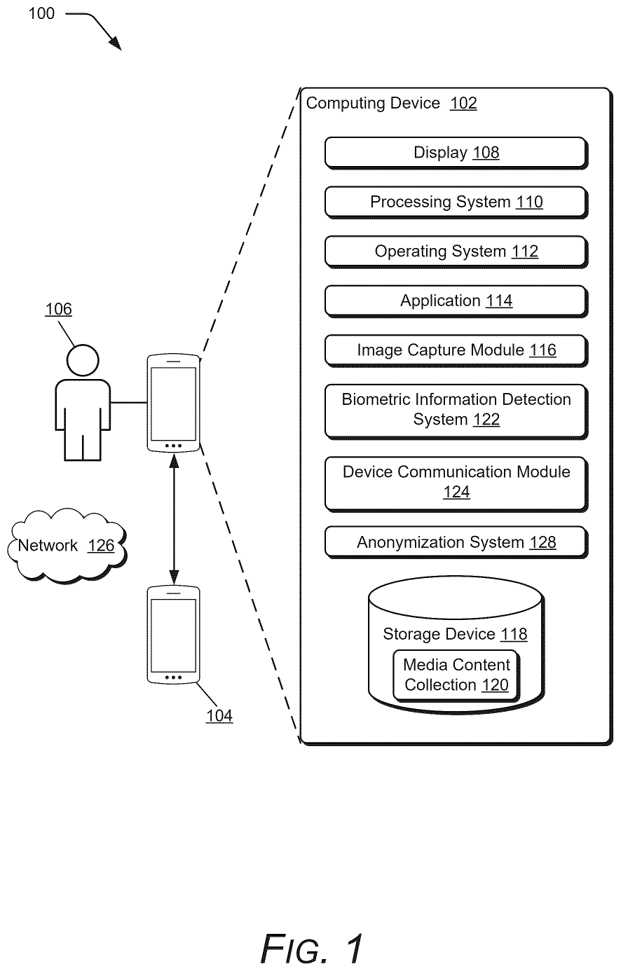

FIG. 1 illustrates an example computing device 102 implementing the techniques discussed herein. The computing device 102 can be, or include, many different types of computing or electronic devices. For example, the computing device 102 can be a smartphone or other wireless phone, a camera (e.g., compact or single-lens reflex), or a tablet or phablet computer. By way of further example, the computing device 102 can be a notebook computer (e.g., netbook or ultrabook), a laptop computer, a wearable device (e.g., a smartwatch, an augmented reality headset or device, a virtual reality headset or device), a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, an automotive computer, and so forth.

The computing device 102 includes a display 108. The display 108 can be configured as any suitable type of display, such as an organic light-emitting diode (OLED) display, active matrix OLED display, liquid crystal display (LCD), in-plane shifting LCD, projector, and so forth. Although illustrated as part of the computing device 102, it should be noted that the display 108 can be implemented separately from the computing device 102. In such situations, the computing device 102 can communicate with the display 108 via any of a variety of wired (e.g., Universal Serial Bus (USB), IEEE 1394, High-Definition Multimedia Interface (HDMI)) or wireless (e.g., Wi-Fi, Bluetooth, infrared (IR)) connections. The display 108 can also optionally operate as an input device (e.g., the display 108 can be a touchscreen display).

The computing device 102 also includes a processing system 110 that includes one or more processors, each of which can include one or more cores. The processing system 110 is coupled with, and may implement functionalities of, any other components or modules of the computing device 102 that are described herein. In one or more embodiments, the processing system 110 includes a single processor having a single core. Alternatively, the processing system 110 includes a single processor having multiple cores or multiple processors (each having one or more cores).

The computing device 102 also includes an operating system 112. The operating system 112 manages hardware, software, and firmware resources in the computing device 102. The operating system 112 manages one or more applications 114 running on the computing device 102, and operates as an interface between applications 114 and hardware components of the computing device 102.

The computing device 102 also includes an image capture module 116. The image capture module 116 captures images digitally using any of a variety of different technologies, such as a charge-coupled device (CCD) sensor, a complementary metal-oxide-semiconductor (CMOS) sensor, combinations thereof, and so forth. The image capture module 116 can include a single sensor and lens, or alternatively multiple sensors or multiple lenses. For example, the image capture module 116 may have at least one lens and sensor positioned to capture images from the front of the computing device 102 (e.g., the same surface as the display is positioned on), and at least one additional lens and sensor positioned to capture images from the back of the computing device 102.

The image capture module 116 can capture still images as well as video. The media content discussed herein refers to one or both of still images and video. In some examples, the image capture module 116 may support an image capture action, and the computing device 102 may detect when an image is captured by the image capture action. The captured images or video are stored in a storage device 118 as a media content collection 120. The storage device 118 can be implemented using any of a variety of storage technologies, such as magnetic disk, optical disc, Flash or other solid state memory, and so forth, and may be implemented as part of the computing device 102 or separately from the computing device 102. In some implementations, the storage device 118 may be cloud-based storage, and the media content may be stored on a remote server (e.g., in the cloud). In such cases, the computing device 102 may still manage the stored media content.

The computing device 102 also includes a biometric information detection system 122, which can be implemented in a variety of different manners. For example, the biometric information detection system 122 can be implemented as multiple instructions stored on computer-readable storage media and that can be executed by the processing system 110. Additionally, or alternatively, the biometric information detection system 122 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). Furthermore, although illustrated as separate from the operating system 112, the biometric information detection system 122 can be implemented at least in part as part of the operating system 112. In some examples, the biometric information detection system 122 may be associated with a security platform supported by the computing device 102 created to safeguard the computing device 102 from malware, phishing, cyberattacks, and other dangers.

Cybersecurity refers to the practice of protecting systems, networks from digital attacks. Cyberattacks are aimed at accessing, changing, or destroying sensitive information, extorting money, or disrupting normal business processes. As technology becomes increasingly more integrated into daily life, the need for strong cybersecurity measures has never been more critical. The scope of cybersecurity includes not only safeguarding personal and organizational data, but also securing systems such as online banking, medical records, and government infrastructure. Any party may be a potential target to cyberattacks and other threats, including individuals using smartphones and large corporations managing critical infrastructure. Cyberattacks and other digital threats may range from relatively simple data breaches to sophisticated attacks by organized cybercriminals, hackers, and other parties. The biometric information detection system 122 may be implemented as part of a cybersecurity platform of the computing device 102, and may assist in preventing cyberattacks on the user 106 of the computing device 102.

Generally, the biometric information detection system 122 detects various biometric information or biometric identities regarding the current user of the computing device 102, the user 106, in media content captured by the image capture module 116 and/or stored in the storage device 118. Various different biometric information can be detected by the biometric information detection system 122, such as face information (e.g., eyes), fingerprint information, hand or palm information, and so forth.

The current user of the computing device 102 is also referred to as the current user that is in possession of the computing device 102 or the user 106 that is currently in possession of the computing device 102. A user being in possession of the computing device 102 refers to a user that is physically in control of or currently accessing the computing device 102 (e.g., the user 106). For example, the user 106 that is holding the computing device 102 (e.g., with his or her hand) is the current user that is in possession of the computing device 102.

Any of a variety of different public or proprietary techniques can be used to identify the biometric information, and the particular techniques implemented by the biometric information detection system 122 can vary based on the particular biometric information that is obtained by the biometric information detection system 122. For example, facial features can be obtained from a current image of the user 106 captured by the image capture module 116 (e.g., a selfie) and can include information regarding size or location of different aspects of a user's face, such as eyes, nose, mouth corners, ears, and so forth. By way of another example, fingerprint features can be obtained from a current image of the user 106 captured by the image capture module 116 (e.g., a selfie where the user is raising their hand or is holding up a “peace” sign with two fingers) and can include information regarding the pattern of ridges or lines on one or more of the user's fingers.

The biometric information detection system 122 may determine that some media content captured by the image capture module 116 and/or stored in the storage device 118 in the media content collection 120 depicts some biometric information of the user 106. For example, if the user 106 takes an image of themselves using the computing device 102, and the image includes biometric features of the user 106 such as their face, palm, fingerprints, and so forth, the biometric information detection system 122 may detect those biometric features and flag or otherwise mark the image. In some examples, the media content collection 120 may include a set of images that include biometric features of the user 106, other users of the computing device 102, or other people that appear in media content in the media content collection 120.

The computing device 102 may also include a device communication module 124 that implements functionality to communicate with one or more other computing devices, such as a computing device 104. By way of example, the computing device 102 may be connected to the computing device 104 via one or more of a wired or wireless connection. For example, the computing devices 102 and 104 can be directly connected to one another (e.g., with no intermediary device or system) or indirectly connected to one another (e.g., via one or more other devices or systems such as a router, switch, hub, wireless access point, and so forth).

Such communication between the computing device 102 and the computing device 104 can take various forms, such as voice calls (e.g., over a cellular system, public switched telephone network (PSTN), network (e.g., using voice over Internet Protocol (VoIP), etc.), short messaging service (SMS) messages, multimedia messaging service (MMS) messages, email, group based chat messaging system, and so forth. This communication can be carried out over a network 126, which can be any of a variety of different networks 126, including the Internet, a local area network (LAN), a public telephone network, a cellular network (e.g., a third generation (3G) network, a fourth generation (4G) network, a fifth generation (5G) network), an intranet, other public or proprietary networks, combinations thereof, and so forth. The computing device 102 and the computing device 104 can thus communicate with other devices wirelessly and accordingly is also referred to as a wireless device.

The device communication module 124 may also implement functionality to detect when the media content is to be communicated to one or more other computing devices, such as a computing device 104. For example, the device communication module 124 may detect if the user 106 begins posting an image of themselves to the Internet via an application 114 (e.g., a social media or photo-sharing application). If the media content that is to be shared includes biometric information of the user 106 or another person (e.g., if the media content is flagged as including biometric information as described herein), then an anonymization system 128 may anonymize the biometric information in the media content. Additionally, or alternatively, the anonymization system 128 may anonymize the biometric information in the media content at other times, such as automatically at the time the media content is captured regardless of whether the media content is to be shared.

The anonymization system 128 can be implemented in a variety of different manners. For example, the anonymization system 128 can be implemented as multiple instructions stored on computer-readable storage media and that can be executed by the processing system 110. Additionally, or alternatively, the anonymization system 128 can be implemented at least in part in hardware (e.g., as an ASIC, a FPGA, an ASSP, a SoC, a CPLD, and so forth). Furthermore, although illustrated as separate from the operating system 112, the anonymization system 128 can be implemented at least in part as part of the operating system 112. In some examples, the anonymization system 128 may be associated with a security platform supported by the computing device 102 created to safeguard the computing device 102 from malware, phishing, cyberattacks, and other dangers.

In some implementations, the anonymization system 128 may include an AI model that may apply random parameters to the media content, effectively obscuring or inpainting the biometric information such that the information no longer identifies the user 106. For example, the AI model may employ generative AI to generate content autonomously based on the media content. Generative AI models may utilize deep learning models (e.g., built upon architectures such as Generative Pre-trained Transformer (GPT)) to understand patterns, relationships, and features within vast datasets. Generative AI models, when trained on diverse and extensive data, may gain the capability to generate new, coherent content that often mimics human-like creativity. Generative AI models are also highly versatile and may be applied across various domains, including natural language processing, image synthesis, and so forth.

When the biometric information in the media content is anonymized, the device communication module 124 may enable the computing device 102 to share or communicate the media content to the computing device 104 and any other computing devices 104. For example, the user 106 of the computing device 102 may send an image directly to a user of the computing device 104 (e.g., via an application 114 for messaging), or the user 106 of the computing device 102 may post the image publicly on a social media website or application. As such, the system 100 may allow the user 106 to take and share images and videos that depict themselves and, in some cases, other people, without risking the exposure of their biometric information.

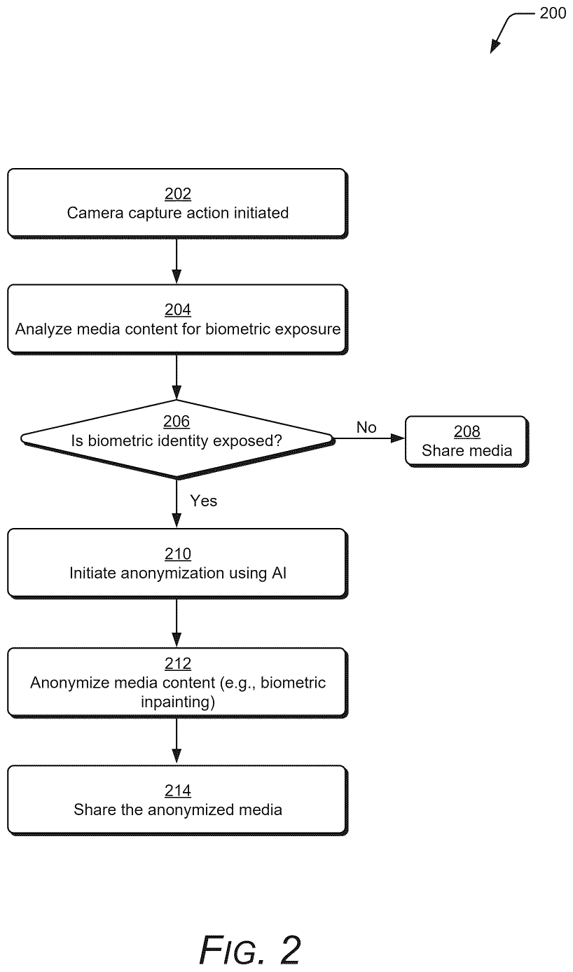

FIG. 2 illustrates an example operation 200 implementing the techniques discussed herein. The operation 200 may be implemented in or otherwise supported by the system 100, as described with reference to FIG. 1. For example, the operation 200 may enable a computing device 102 to process media content in order to anonymize biometric information in the media content. The operation 200 illustrates an example of the techniques discussed herein, though steps of the operation 200 may be performed in different orders.

At 202, the computing device (e.g., a mobile device such as a smartphone) may initiate a camera capture action or an image capture action. The computing device may include a display and an image capturing device (e.g., a camera). In such cases, initiating the camera or image capture action may include taking some media content using the image capturing device, which may appear on the display of the computing device. The media content may include an image, a sequence or series of images, or a video.

At 204, the computing device may analyze the media content for biometric exposure. That is, the computing device may analyze the captured image, images, or video to determine if any aspect of the user's biometric identity is being exposed by the media content. Aspects of the user's biometric identity may include the user's fingerprints, palm, face, eyes, or other biometric features that may appear in an image or video of the user. For example, the media content may expose the user's biometric identity if the user took a selfie or posed for a photo alone or with other people and that photo shows the user's face, fingerprints, and so forth.

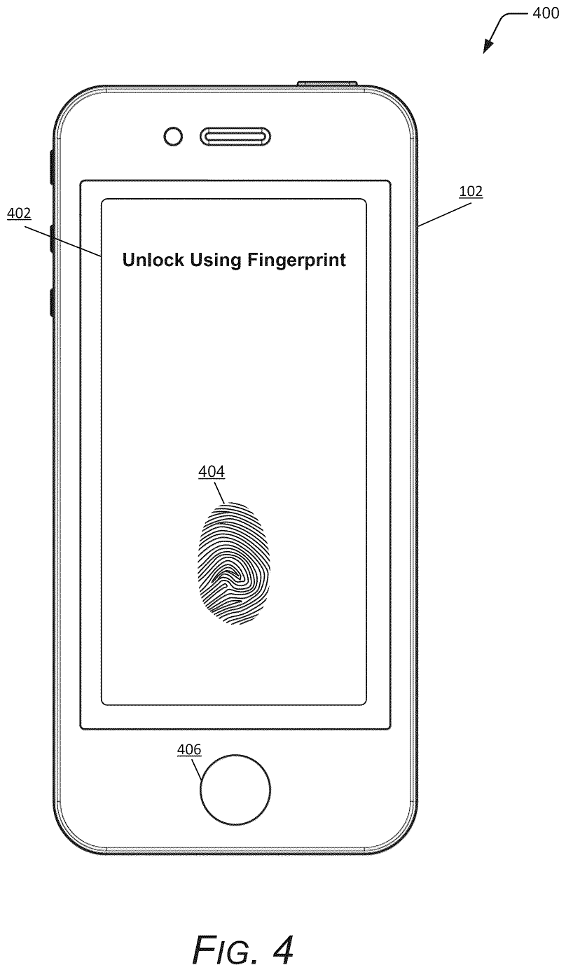

At 206, the computing device may determine if any aspect of the user's biometric identity is being exposed by the media content. In some examples, the computing device may determine that the biometric identity is linked with authentication of an application or a service, as described with reference to FIG. 4. In some implementations, if the media content is stored at the computing device or a remote server (e.g., the cloud), then the computing device may tag or mark the media content in storage that includes biometric information in case the user decides to share that media content at a later time.

Additionally, or alternatively, the computing device may determine that the media content with the exposed biometric identity is to be shared to other computing devices via a public post or a social media application. For example, the computing device may determine that a user has opened a photo-sharing, messaging, or social media application and uploaded the media content to the application. When shared in this way, the media content may be viewed by a public audience (e.g., anyone also using that application).

At 208, if the computing device determines that the media content does not expose the biometric identity of the user, the then the computing device may allow the user to share the media to the public. For example, if the media content is an image of the user's pet, a nature scene, or another object that does not include the user or another person, then the first user may share the media content. In other examples, if the media content is an image that depicts only a part of the user's face (e.g., because of the angle the image was taken at, because the user's hair is covering most of their face, etc.), then the first device may also determine that the biometric identity of the user is not being exposed and allow the user to share the media content.

Alternatively, at 210, if the computing device determines that the media content does expose the biometric identity of the user, the then the computing device may initiate anonymization of the biometric information in the media content using AI.

At 212, the computing device may anonymize the media content, for example, using biometric inpainting. By way of example, using AI, the first device may introduce noise to an image that depicts the user's face and eyes by adding random, imperceptible specks (e.g., pixels) to the image. Such random parameters may effectively blur out or obscure the biometric information such that it no longer identifies the user. In this way, while the image may appear no different to a viewer, the eyes in the image may no longer identify the user (where before the anonymization, the eyes may have identified the user and been used to authenticate a device, for example).

At 214, the computing device may share the anonymized media content with other computing devices. For example, the user of the computing device may upload or post an image of themselves on a social media application, a website, or another public platform.

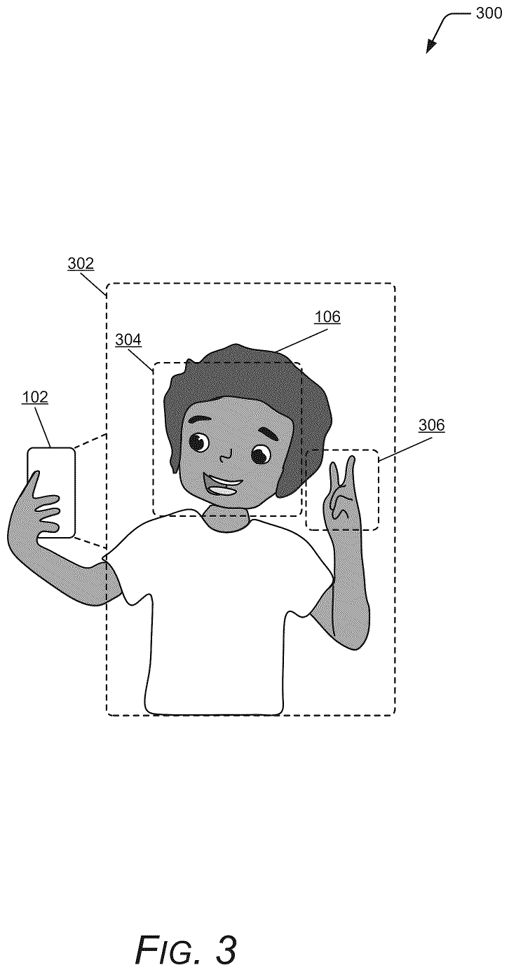

FIG. 3 illustrates an example of biometric information 300 implementing the techniques discussed herein. Selfies, or self-portrait photographs taken by a user of a mobile device and using the mobile device, have become a popular form of self-expression and social interaction. For example, a user 106 (e.g., an information technology (IT) professional), often shares moments of his life on social media. During a hiking trip, the user 106 may use a computing device 102 (e.g., a smartphone) to take an image 302 at the summit of the hike. The image 302 (e.g., a selfie) may depict the user 106 holding up his hand in a peace sign gesture. The computing device 102 may capture the image 302 using a high-resolution camera, and as such, the camera may capture the fine details of the user's face 304, eyes, and fingerprints 306 (or at least the user's fingertips) in the image 302.

The image 302 may expose the biometric identity of the user 106. That is, the image 302 may depict the user's face 304, including the user's eyes, and the user's fingerprints 306. The face, eyes, and fingerprints of the user 106 include biometric information of the user which may be used to authenticate the computing device 102, for example, but which also may be obtained by unauthorized parties for identity theft, unauthorized access, and other unauthorized actions. Unaware of these dangers, the user 106 may post the image online (e.g., on a social media platform). A hacker skilled in biometric data extraction may find the image 302 and use an AI-powered inpainting software to reconstruct the user's fingerprints 306 from what is visible in the image 302. Within weeks, the user's computing device 102 and laptop, which may use fingerprint authentication as described with reference to FIG. 4, may be accessed by the hacker without the user's permission. The hacker may thus successfully bypass the security of the computing device 102 using the user's own biometric data.

The example of FIG. 3 highlights how even small details in photos (e.g., fingerprints) may pose significant security risks, particularly when shared online. The example underscores the need for awareness of how much detail modern cameras can capture and the risks of sharing such images publicly, especially as biometrics become a key element of cybersecurity. To prevent recognition and theft of the user's biometric identity from the image 302, the computing device 102 may anonymize the biometric information as described herein before the user 106 shares the image 302 with the public (e.g., via a social media platform).

FIG. 4 illustrates an example of device authentication 400 implementing the techniques discussed herein. A user may access an application 402 via a computing device 102 (e.g., a mobile device such as a smartphone). Some applications 402 may require the user to authenticate their account before logging in. For example, mobile banking applications, e-mail applications, social media applications, and so forth may require the user to input a correct username and password in order to login. Such applications 402 may support other types of authentication, such as facial recognition or fingerprint recognition. Additionally, or alternatively, the user may be required to input a username and password, a passcode, or use facial or fingerprint recognition in order to unlock the computing device 102 for use.

In the example of FIG. 4, the application 402 may prompt the user to unlock the screen using their fingerprint 404 in order to login and access the application 402. The user may place their fingerprint 404 directly on the screen of the computing device 102 or on a button or capacitive surface 406 of the computing device to successfully access the application 402.

As described herein, the computing device 102 may detect when the user has taken an image or video of themselves that exposes the biometric identity of the user, including their fingerprint (e.g., the fingerprint 404 that is used to access the application 402). The computing device 102 may determine that some biometric information depicted in the image or video is linked with the authentication of the application 402 or another service associated with the computing device 102, which may further prompt the computing device 102 to anonymize the biometric information in the image or video as described herein. This would prevent another user, with access to the image or video, from using the image or video to access the application 402.

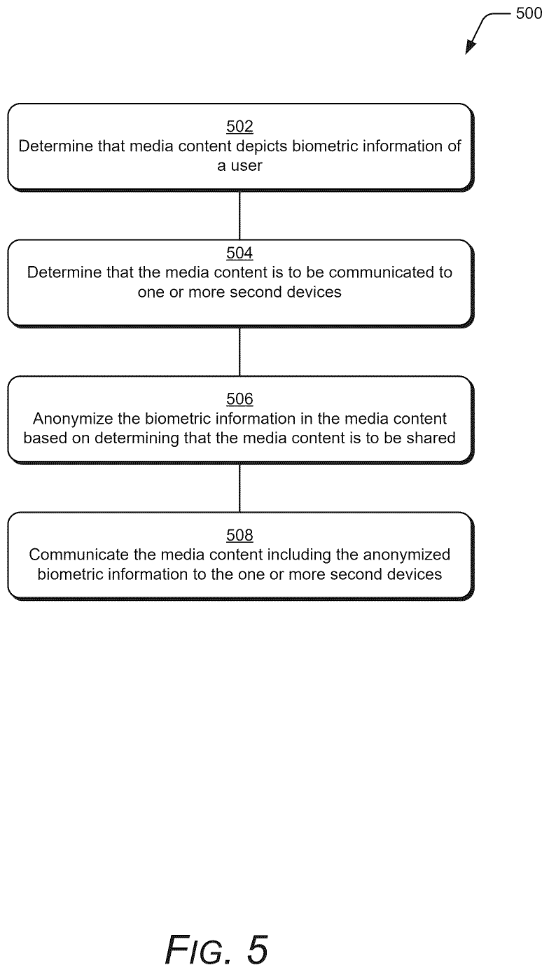

FIG. 5 illustrates an example process 500 for implementing the techniques discussed herein in accordance with one or more embodiments. The process 500 may be carried out by an image capture module, a biometric information detection system, a device communication module, an anonymization system, or a combination thereof, such as the image capture module 116, the biometric information detection system 122, the device communication module 124, and anonymization system 128 of FIG. 1, and can be implemented in software, firmware, hardware, or combinations thereof. The process 500 is shown as a set of acts and is not limited to the order shown for performing the operations of the various acts.

In the process 500, a computing device (e.g., a mobile device, a smartphone) may determine that media content depicts biometric information of a user (act 502). By way of example, a user 106 may take a selfie or other image or video of themselves using a camera of the computing device (e.g., using the image capture module 116). The biometric information detection system 122 may identify that the media content exposes the biometric identity of the user 106 by depicting biometric information such as the user's face, eyes, fingerprints, palm, and so forth.

The computing device may determine that the media content is to be communicated to one or more second devices (act 504). By way of example, the device communication module 124 may detect the user 106 uploading an image of themselves to a social media platform.

Based on determining that the media content is to be shared, the computing device may anonymize the biometric information in the media content (act 506). By way of example, the anonymization system 128 may employ an AI model to apply random parameters (e.g., noise) to the media content. The random parameters may add or distort the pixels of the media content such that the biometric information (e.g., eyes, fingerprints, etc.) in the media content are no longer associated with the identity of the user 106.

The computing device may communicate the media content including the anonymized biometric information to the one or more second devices (act 508). By way of example, the device communication module 124 may enable the user 106 to pose the media content to a social media platform or other public application online since the biometric information in the media content no longer exposes the identity of the user 106.

In some examples, the process 500 may be performed in a different order, include additional acts, or exclude any of the acts described herein. For example, in some implementations the computing device may anonymize the biometric information in the media content when the computing device captures (or receives or obtains) the media content, prior to making any determination about whether the media content is going to be communicated to other computing devices. In another example, the

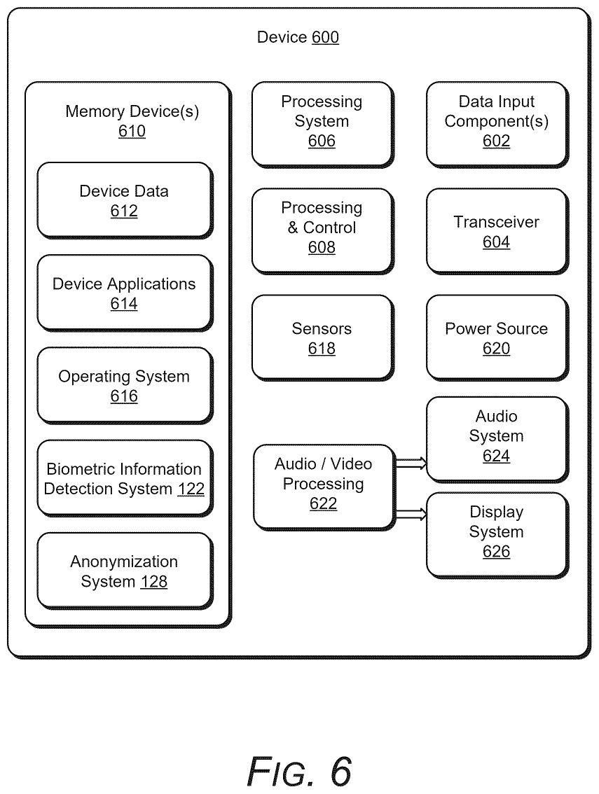

FIG. 6 illustrates various components of a device 600 that can implement embodiments of the techniques discussed herein. The device 600, which may be a computing device or an electronic device, can be implemented as any of the devices described with reference to the previous FIG. s, such as any type of client device, mobile phone, tablet, computing, communication, entertainment, gaming, media playback, or other type of electronic device. In one or more implementations, the device 600 includes the biometric information detection system 122 and the anonymization system 128 discussed above.

The device 600 includes one or more data input components 602 via which any type of data, media content, or inputs can be received such as user-selectable inputs, messages, music, television content, recorded video content, and any other type of text, audio, video, or image data received from any content or data source. The data input components 602 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 602 may also include various other input components such as microphones, touch sensors, touchscreens, keyboards, and so forth.

The device 600 includes communication transceivers 604 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The device 600 includes a processing system 606 of one or more processors (e.g., any of microprocessors, controllers, and the like) or a processor and memory system implemented as a system-on-chip (SoC) that processes computer-executable instructions. The processing system 606 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 608. The device 600 may further include any type of a system bus or other data and command transfer system that couples the various components within the device. A system bus can include any one or combination of different bus structures and architectures, as well as control and data lines.

The device 600 also includes computer-readable storage memory devices 610 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 610 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device.

The computer-readable storage memory device 610 provides data storage mechanisms to store the device data 612, other types of information or data, and various device applications 614 (e.g., software applications). For example, an operating system 616 can be maintained as software instructions with a memory device and executed by the processing system 606 to cause the processing system 606 to perform various acts. The device applications 614 may also include a device manager, such as any form of a control application, software application, signal-processing and control module, code that is native to a particular device, a hardware abstraction layer for a particular device, and so on.

The device 600 can also include one or more device sensors 618, such as any one or more of an ambient light sensor, a proximity sensor, a touch sensor, an infrared (IR) sensor, accelerometer, gyroscope, thermal sensor, audio sensor (e.g., microphone), and the like. The device 600 can also include one or more power sources 620, such as when the device 600 is implemented as a mobile device. The power sources 620 may include a charging or power system, and can be implemented as a flexible strip battery, a rechargeable battery, a charged super-capacitor, or any other type of active or passive power source.

The device 600 additionally includes an audio or video processing system 622 that generates one or both of audio data for an audio system 624 and display data for a display system 626. In accordance with some embodiments, the audio/video processing system 622 is configured to receive call audio data from the transceiver 604 and communicate the call audio data to the audio system 624 for playback at the device 600. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

In the discussions herein, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Although embodiments of techniques for processing media content to anonymize biometric information have been described in language specific to features or methods, the subject of the appended claims is not necessarily limited to the specific features or methods described. Rather, the specific features and methods are disclosed as example implementations of techniques for implementing processing media content to anonymize biometric information. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a first device, including: at least one memory; and at least one processor coupled with the at least one memory and configured to cause the first device to: determine that media content depicts biometric information of a user; determine that the media content is to be communicated to one or more second devices; anonymize the biometric information in the media content based on determining that the media content is to be communicated; and communicate the media content including the anonymized biometric information to the one or more second devices.

In some aspects, the techniques described herein relate to a first device, wherein the at least one processor is configured to cause the first device to: determine that the biometric information is associated with authentication of an application.

In some aspects, the techniques described herein relate to a first device, wherein, to anonymize the biometric information, the at least one processor is configured to cause the first device to: initiate anonymization of the biometric information using an AI model.

In some aspects, the techniques described herein relate to a first device, wherein anonymizing the biometric information using the AI model comprises applying a set of random parameters to the media content.

In some aspects, the techniques described herein relate to a first device, wherein the at least one processor is configured to cause the first device to: capture, by an image capture action, the media content.

In some aspects, the techniques described herein relate to a first device, wherein the media content is to be communicated to the one or more second devices via a public post on a social media platform.

In some aspects, the techniques described herein relate to a first device, wherein the media content comprises at least one of an image, a sequence of images, or a video.

In some aspects, the techniques described herein relate to a first device, wherein biometric information comprises at least one of a fingerprint, a palm, a face, or eyes of the user.

In some aspects, the techniques described herein relate to a first device, wherein the at least one processor is configured to cause the first device to: store the media content at a data store, wherein the media content is labeled as depicting the biometric information.

In some aspects, the techniques described herein relate to a method at a first device, the method comprising: determining that media content depicts biometric information of a user; determining that the media content is to be communicated to one or more second devices; anonymizing the biometric information in the media content based on determining that the media content is to be communicated; and communicating the media content including the anonymized biometric information to the one or more second devices.

In some aspects, the techniques described herein relate to a method, further comprising: determining that the biometric information is associated with authentication of an application.

In some aspects, the techniques described herein relate to a method, wherein anonymizing the biometric information further comprises: initiating anonymization of the biometric information using an AI model.

In some aspects, the techniques described herein relate to a method, wherein anonymizing the biometric information using the AI model comprises applying a set of random parameters to the media content.

In some aspects, the techniques described herein relate to a method, further comprising: capturing, by an image capture action, the media content.

In some aspects, the techniques described herein relate to a method, wherein the media content is to be communicated to the one or more second devices via a public post on a social media platform.

In some aspects, the techniques described herein relate to a method, wherein the media content comprises at least one of an image, a sequence of images, or a video.

In some aspects, the techniques described herein relate to a method, wherein biometric information comprises at least one of a fingerprint, a palm, a face, or eyes of the user.

In some aspects, the techniques described herein relate to a method, further comprising: storing the media content at a data store, wherein the media content is labeled as depicting the biometric information.

In some aspects, the techniques described herein relate to a system, including: a data store; and a processing system to: determine that media content depicts biometric information of a user; determine that the media content is to be communicated to one or more second devices; anonymize the biometric information in the media content based on determining that the media content is to be communicated; and communicate the media content including the anonymized biometric information to the one or more second devices.

In some aspects, the techniques described herein relate to a system, wherein the processing system is further configured to: determine that the biometric information is associated with authentication of an application.

What is claimed is:

1. A first device, comprising:
at least one memory; and
at least one processor coupled with the at least one memory and configured to cause the first device to:
determine that media content depicts biometric information of a user;
determine that the media content is to be communicated to one or more second devices;
anonymize the biometric information in the media content based on determining that the media content is to be communicated; and
communicate the media content including the anonymized biometric information to the one or more second devices.

2. The first device of claim 1, wherein the at least one processor is further configured to cause the first device to determine that the biometric information is associated with authentication of an application.

3. The first device of claim 1, wherein, to anonymize the biometric information, the at least one processor is configured to cause the first device to initiate anonymization of the biometric information using an artificial intelligence (AI) model.

4. The first device of claim 3, wherein anonymizing the biometric information using the AI model comprises applying a set of random parameters to the media content.

5. The first device of claim 1, wherein the at least one processor is further configured to cause the first device to capture, by an image capture action, the media content.

6. The first device of claim 1, wherein the media content is to be communicated to the one or more second devices via a public post on a social media platform.

7. The first device of claim 1, wherein the media content comprises at least one of an image, a sequence of images, or a video.

8. The first device of claim 1, wherein the biometric information comprises at least one of a fingerprint, a palm, a face, or eyes of the user.

9. The first device of claim 1, wherein the at least one processor is further configured to cause the first device to store the media content at a data store, wherein the media content is labeled as depicting the biometric information.

10. A method at a first device, the method comprising:
determining that media content depicts biometric information of a user;
determining that the media content is to be communicated to one or more second devices;
anonymizing the biometric information in the media content based on determining that the media content is to be communicated; and
communicating the media content including the anonymized biometric information to the one or more second devices.

11. The method of claim 10, further comprising determining that the biometric information is associated with authentication of an application.

12. The method of claim 10, wherein anonymizing the biometric information further comprises initiating anonymization of the biometric information using an artificial intelligence (AI) model.

13. The method of claim 12, wherein anonymizing the biometric information using the AI model comprises applying a set of random parameters to the media content.

14. The method of claim 10, further comprising capturing, by an image capture action, the media content.

15. The method of claim 10, wherein the media content is to be communicated to the one or more second devices via a public post on a social media platform.

16. The method of claim 10, wherein the media content comprises at least one of an image, a sequence of images, or a video.

17. The method of claim 10, wherein the biometric information comprises at least one of a fingerprint, a palm, a face, or eyes of the user.

18. The method of claim 10, further comprising storing the media content at a data store, wherein the media content is labeled as depicting the biometric information.

19. A system, comprising:
a data store; and
a processing system to:
determine that media content depicts biometric information of a user;
determine that the media content is to be communicated to one or more second devices;
anonymize the biometric information in the media content based on determining that the media content is to be communicated; and
communicate the media content including the anonymized biometric information to the one or more second devices.

20. The system of claim 19, wherein the processing system is further configured to determine that the biometric information is associated with authentication of an application.
